(19) United States
(12) Patent Application Publication
(10) Pub. No.: US 2025/0345807 A1
(43) Pub. Date: Nov. 13, 2025

(54) A SYSTEM FOR SEPARATING A LIQUID FEED MIXTURE

(71) Applicant: Alfa Laval Corporate AB, LUND (SE)

(72) Inventor: Peter THORWID, SUNDBYBERG (SE)

(73) Assignee: Alfa Laval Corporate AB, LUND (SE)

(21) Appl. No.: 18/871,692

(22) PCT Filed: Jun. 8, 2023
(86) PCT No.: PCT/EP2023/065409

§ 371 Date: Dec. 4, 2024

(30) Foreign Application Priority Data
Jun. 28, 2022 (EP) 22181536.8

(51) Int. Cl. B04B 1/08

(52) U.S. Cl. CPC B04B 1/08

(57) ABSTRACT

A system for separating at least a first liquid phase from liquid feed mixture includes a centrifugal separator, which includes a centrifuge bowl arranged to rotate around an axis of rotation and in which the separation of the liquid feed mixture takes place, an inlet for receiving said liquid feed mixture, and a first liquid outlet for discharging the first liquid phase. The first liquid outlet is hermetically sealed and free of any dedicated device for converting the kinetic energy of the first liquid phase into pressure flow of the first liquid phase. The system includes a pressure generating device for supplying the liquid feed mixture to the inlet of the centrifugal separator, and the system is configured such that the pressure generating device is the major flow regulating device arranged for creating the required outlet pressure for transportation of the first liquid phase from the first liquid outlet.

### FIELD OF THE INVENTION

The present invention relates to the field of centrifugal separators, and more specifically to a system comprising a centrifugal separator for separating at least a first liquid phase from a liquid feed mixture.

### BACKGROUND OF THE INVENTION

Centrifugal separators are generally used for separation of liquids and/or for separation of solids from a liquid. During operation, liquid mixture to be separated is introduced into a rotating centrifuge bowl and heavy particles or denser liquid, such as water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

Mechanical seals may be arranged between a stationary portion of the centrifugal separator and the centrifuge bowl for sealing a fluid path extending therebetween. In a centrifugal separator being hermetically sealed at the inlet and a liquid outlet, a separated liquid phase may be pumped out under pressure by a pump that converts the kinetic energy of the separated phase into pressure. Such a pump may be a pump wheel or a paring device, such as a paring disc. Further, these devices require a controlled back pressure for optimal functionality.

In order to create a flow of process fluid through such a hermetic separator, an inlet pressure may be provided to overcome the pressure drop in the separator. The inlet pressure is usually provided by a feed pump arranged for transporting the feed mixture to be separated to the centrifugal separator. Examples of hermetically sealed centrifugal separators are disclosed in EP2868210 and EP3769846.

However, there is still a need for improvements in centrifugal separators having at least one hermetic outlet. Also, there are higher demands in the field for providing separation systems that requires less energy for the separation process.

### SUMMARY OF THE INVENTION

It is an object of the invention to at least partly overcome one or more limitations of the prior art. In particular, it is an object to provide a system for separating a liquid feed mixture having a reduced energy consumption.

As a first aspect of the invention, there is provided a system for separating at least a first liquid phase from liquid feed mixture, said system comprising
a centrifugal separator, which comprises
   a centrifuge bowl arranged to rotate around an axis of rotation (X) and in which the separation of the liquid feed mixture takes place,
   an inlet for receiving said liquid feed mixture, and
   a first liquid outlet for discharging the first liquid phase, wherein said first liquid outlet is hermetically sealed and free of any dedicated device for converting the kinetic energy of the first liquid phase into pressure flow of the first liquid phase, and wherein the system further comprises
a pressure generating device for supplying the liquid feed mixture to the inlet of the centrifugal separator, and
wherein the system is configured such that the pressure generating device is the major flow regulating device arranged for creating the required outlet pressure for transportation of the first liquid phase from the first liquid outlet.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X) and thus perpendicular to the rotational axis (X). A “radially inner position” thus refers to a position closer to the rotational axis (X) compared to “a radially outer position”. A “radial plane” is a plane extending in the radial direction and having a normal extending in the axial direction. In analogy, an “axial plane” is a plane extending in the axial direction and having a normal extending in the radial direction.

The “dedicated device for converting the kinetic energy of the first liquid phase into pressure flow of the first liquid phase” may be a product discharge pump for discharging the first liquid phase. Such devices are often arranged in an outlet chamber, such as in a paring chamber, of the centrifuge bowl. The product discharge pump may be a paring device, such as a stationary paring disc, as known in the art. The product discharge pump may also be a centrifugal pump, such as a pump wheel rotating with the centrifugal bowl. The centrifugal pump may also be a pump standing still.

The “dedicated device for converting the kinetic energy of the first liquid phase into pressure flow of the first liquid phase” may be a device that has the conversion of kinetic energy into pressure flow as its major function. As an example, the “dedicated device” may not form a part of an outlet seal. Thus, some parts of an outlet seal, such as a mechanical seal, may convert a minor portion of kinetic energy into pressure flow of a liquid phase. However, the major use of such part of a seal is of course to aid in the sealing function of the seal and is thus not a “dedicated device” according to the first aspect.

The first liquid outlet is in fluid communication with the separation space of the centrifuge bowl. The first liquid outlet forms a fluid path out of the centrifuge bowl. The first liquid outlet is hermetically sealed. A hermetically sealed outlet may be sealed using a liquid seal (a hydrohermetic seal) or a mechanical seal. A mechanically sealed hermetic outlet is sealed from the surroundings of the rotor and is arranged to be filled with liquid product during operation. Thus, in contrast to separators having a pairing disc at the liquid outlets, the mechanically hermetically sealed separator has no liquid-air interfaces at the outlets.

In embodiments, the first liquid outlet is mechanically hermetically sealed.

The mechanical seal of a mechanically sealed liquid outlet may be a double mechanical seal, i.e. comprising a rotatable portion and a stationary portion forming the sealing interface therebetween. The sealing interface may extend in the radial plane. The stationary portion may be connected to a stationary outlet pipe, whereas the rotatable portion of the seal may be attached to the centrifuge bowl.

The pressure generating device may be a liquid feed pump. However, a “pressure generating device” may also be achieved by supplying the liquid feed mixture from a certain height above the centrifugal separator. Thus, the system may comprise a tank for liquid feed mixture to be separated, and such tank may be arranged at a height above the centrifugal separator in order to create the required inlet pressure. Thus, the pressure generating device may be “built-in” into the arrangement of the components of the system.

The “pressure generating device being the major flow regulating device arranged for creating the required outlet pressure for transportation of the first liquid phase from the first liquid outlet” refers to the pressure generating device creating the largest outlet pressure for transportation of the first liquid phase from the first liquid outlet

In embodiments, the pressure generating device is the only flow regulating device arranged for creating the required outlet pressure for transportation of the first liquid phase from the first liquid outlet.

However, the centrifugal separator may be designed so that the centrifuge bowl in itself generates a flow of the first liquid phase from the first liquid outlet during rotation. This may be the case e.g. if the first liquid outlet is arranged at a larger radius than the inlet, such as if the inlet is arranged at the rotational axis (X) and the first liquid outlet is arranged at a radius from the rotational axis (X).

The first aspect of the invention is based on the insight that a hermetic outlet may be designed without a dedicated device used for converting the kinetic energy of a separated liquid phase into pressure flow, such that e.g. a liquid feed pump is the major, or only, device used for providing the sufficient pressure to a separated liquid phase to flow out from the separator. A pressure generating device such as a liquid feed pump may be designed in a more energy efficient way than the traditional devices—such as a paring disc or pump wheel—used for converting the kinetic energy into pressure flow. Thus, the centrifugal separator may be free of any internal means dedicated for generating an outlet pressure for the first liquid phase, except for the rotating centrifuge bowl itself.

Moreover, the inventors have realised that with such design, there is no need for a pressure regulating valve downstream of the outlet for controlling the counter pressure. Such pressure regulating valves usually lead to a pressure drop, and a loss of energy. In other words, the first aspect allows for a separation system without a pressure regulating valve downstream of the outlet and thus a reduced energy consumption.

In embodiments of the first aspect, the centrifugal separator is free of further liquid outlets for discharge of further separated liquid phases. Consequently, the centrifugal separator may be a clarifier separator. A clarifier is a centrifugal separator for solid—liquid separation, which removes solids such as particles, sediments from the liquid feed mixture. In doing so, the process liquid becomes clear. Thus, the centrifugal separator may have a single liquid outlet for a separated liquid phase.

However, the centrifugal separator may further comprise at least one sludge outlet for a separated solids phase. Such sludge outlet may be arranged at the periphery of the centrifuge bowl.

The centrifugal separator may thus be arranged to separate the liquid feed mixture into a liquid light phase and a sludge phase.

The at least one sludge outlet may be in the form of a set of open nozzles arranged for continuously discharging a separated sludge phase. Such nozzles may be used when the sludge content of the liquid feed mixture is high.

As an alternative, the at least one sludge outlet is in the form of a set of intermittently openable outlets. Such outlets may thus be in the form of a plurality of peripheral ports that extend from the centrifuge bowl to a surrounding space outside the centrifuge bowl. The peripheral ports may be intermittently openable during a short time period, e.g. in the order of a fraction of a second, and permit total or partial discharge of sludge from the centrifuge bowl, using a conventional intermittent discharge system as known in the art.

As an example, when the centrifugal separator is free of further liquid outlets for discharge of further separated liquid phases, the system may further comprise a tank downstream of said first liquid outlet. The system may then be free of any pressure regulating valve between the first liquid outlet and the tank. Such pressure regulating valves are arranged for generating a counter pressure to the first liquid outlet.

Pressure regulating valves, such as flow regulating valves, or flow control valves, downstream of a liquid outlet is usually required to provide a controlled counter pressure for optimal functionality of the centrifugal separator. In almost every installation that counter pressure is more than what is required for downstream transportation of the separated liquid phase. That pressure drop is a loss of energy and in most cases not of any other benefit. The inventors have thus realised that with a hermetic outlet design without any dedicated device for converting the kinetic energy of separated liquid phase into pressure flow of the first liquid phase, no extra counter pressure is needed for clarifier separators.

A pressure regulating valve is usually arranged to control the flow of the liquid phase by varying the size of the flow passage.

A check valve may not be such as pressure regulating valve.

The tank may be arranged for holding the discharged first liquid phase for a period of time before it is used downstream. The tank may thus be a storage tank.

However, the system may comprise further process equipment between the centrifugal separator and the tank, such as a heat exchanger or the like. Consequently, the system may also be free of any pressure regulating valves between such further process equipment and the tank.

As a further example, the centrifugal separator may be arranged such that the liquid feed mixture enters the centrifuge bowl axially from the top. The liquid feed mixture may then enter the centrifuge bowl via a stationary inlet pipe extending into the bowl. The liquid feed mixture may enter the centrifugal separator at the rotational axis (X), and the first liquid outlet is arranged such that the first liquid phase is discharged at a radial distance from the rotational axis (X). Moreover, the first liquid outlet may also be arranged axially at the top of the centrifuge bowl.

As a further example, also the inlet may be hermetically sealed. As with the first liquid outlet, the inlet may be sealed by a hydrohermetic seal or a mechanical seal. A mechanically hermetically sealed inlet is sealed from the surroundings of the rotor and is arranged to be filled with fluid product during operation. Thereby the inlet and the separation space of the centrifuge bowl are connected in pressure communicating manner.

As an example, the inlet and the first liquid outlet may be hermetically sealed by means of at least one mechanical seal. As an example, the sealing interfaces of the at least one mechanical seal may be arranged in the same radial plane.

The at least one mechanical seal may have stationary parts that may be released from the centrifuge bowl in the same singe unit. This may facilitate mounting and service of the at least one mechanical seal.

The inlet and the first liquid outlet may be hermetically sealed by a single mechanical seal having its sealing interfaces in the same radial plane. The single mechanical seal may comprise a rotatable portion—such as a wear ring—and a stationary portion—such as a seal ring—forming the sealing interface therebetween.

The inlet and the first liquid outlet may be sealed using a sealing arrangement and a stationary liquid passage device arranged at the top of the centrifugal separator. Such a sealing arrangement may form an interface between the centrifuge bowl and the stationary liquid passage device. A first liquid path may extend concentrically with a rotational axis between the stationary liquid passage device and the bowl, and a second liquid path may extend radially outside the first liquid path between the stationary liquid passage device and the bowl. The stationary liquid passage device may be releasably connected to a frame of the centrifugal separator. The sealing arrangement may comprise a first seal between the first liquid path and the second liquid path, the first seal extending concentrically with and around the rotational axis, and a second seal between the second liquid path and a space radially outside the second liquid path, the second seal extending concentrically with and around the rotational axis. The first seal may comprise a first seal member arranged in the stationary liquid passage device and a first sealing surface arranged in the bowl, the first seal member having a first axial end face, the first axial end face and the first sealing surface being configured to be positioned in sealing abutment. The second seal may comprise a second seal member arranged in the stationary liquid passage device and a second sealing surface arranged in the bowl, the second seal member having a second axial end face, the second axial end face and the second sealing surface being configured to be positioned in sealing abutment. The second seal member is separate from the first seal member, and the first and second seal member, are separable from the first and second sealing surfaces together with a release of the stationary liquid passage device from the housing.

However, the inlet and the first liquid outlet may also be sealed by two different mechanical seals having their sealing interfaces in different radial planes.

As a further example, the centrifugal separator may be arranged such that the liquid feed mixture enters the centrifuge bowl axially from the bottom. The clarifier separator may thus be a bottom-fed centrifugal separator. The centrifugal separator may then be arranged such that the liquid feed mixture enters the centrifuge bowl from the bottom via a drive spindle of the centrifuge bowl, i.e. at the rotational axis

(X). For such a design, the first liquid outlet may be arranged at the top of the centrifuge bowl, such as at the rotational axis (X) or a radial distance from the rotational axis (X).

In embodiments of the first aspect, the centrifugal separator comprises a second liquid outlet for discharging a second liquid phase having a density that is higher than the density of the first liquid. The first liquid phase could thus be a liquid light phase and the second liquid phase could be a liquid heavy phase. A “liquid light phase” refers to a separated liquid having a density that is lower than the density of a “liquid heavy phase”. Thus, the liquid feed mixture may be separated into at least a liquid light phase and a liquid heavy phase. Also a solids phase may be separated in the centrifugal separator. The centrifugal separator may thus be arranged to separate the liquid feed mixture into a liquid light phase, a liquid heavy phase and a solids phase, i.e. a sludge phase, and hence, the centrifugal separator may comprise a first liquid outlet for a liquid light phase, a second liquid outlet for a light heavy phase and sludge outlets for separated solids.

The at least one sludge outlet may be in the form of a set of open nozzles arranged for continuously discharging a separated sludge phase. Such nozzles may be used when the sludge content of the liquid feed mixture is high.

As an alternative, the at least one sludge outlet is in the form of a set of intermittently openable outlets. Such outlets may thus be in the form of a plurality of peripheral ports that extend from the centrifuge bowl to a surrounding space outside the centrifuge bowl. The peripheral ports may be intermittently openable during a short time period, e.g. in the order of a fraction of a second, and permit total or partial discharge of sludge from the centrifuge bowl, using a conventional intermittent discharge system as known in the art

Consequently, the centrifugal separator could be a purifier for liquid—liquid—solid separation, which separates two liquids of different densities, and a solids, from each other. Using a purifier the light liquid phase is typically the large fraction which is meant to cleaned. The centrifugal separator could also be a concentrator arranged to separate three different phases, one solid phase and two liquid phases of different densities and clean the densest/heaviest liquid phase.

As an example, also the second liquid outlet may be hermetically sealed and free of any dedicated device for converting the kinetic energy of the second liquid phase into pressure flow of the second liquid phase. The hermetic seal may be a hermetic seal discussed in relation to the first liquid outlet above, such a mechanical seal.

For a centrifugal separator comprising a second liquid outlet for discharging a second liquid phase having a density that is higher than the density of the first liquid, pressure regulating means may be needed downstream of both liquid outlets for back pressure control, i.e. for control of the interphase level between the phases within the centrifuge bowl, but not for liquid transportation. The inventors have realised that such pressure regulating means do not need to be flow regulating valves. Thus, in examples, the system comprises a first pressure regulating means downstream of the first liquid outlet and a second pressure regulating means downstream of the second liquid outlet; wherein said first and second pressure regulating means are arranged for regulating the interface between the liquid phases within the centrifuge bowl and are other means than pressure regulating valves.

Such pressure regulating means other than flow regulating valves may for examples be a positive displacement pump, such as a peristaltic pump.

Moreover, according to embodiments, the second liquid outlet is an open outlet formed by an annular gravity disc.

An open outlet and a gravity disc may thus form an overflow outlet for the separated second liquid phase. The gravity disc may be an annular member that functions as a weir and determines the radial position of the overflow to the open outlet for the separated second liquid phase.

The second liquid outlet may thus not be hermetically sealed.

As discussed in relation to the clarifier separator above, also when the centrifugal separator comprises a second liquid outlet, the centrifugal separator may be arranged such that the liquid feed mixture enters the centrifuge bowl axially from the top. For this purpose, the centrifugal separator may comprise a stationary liquid inlet pipe extending into the centrifuge bowl.

Furthermore, as an example, the liquid feed mixture may then enter the centrifugal separator at the rotational axis (X), and the first and second liquid outlets may be arranged such that the first and second liquid phases are discharged at different radial distances from the rotational axis (X). The first liquid outlet may be arranged at a shorter radial distance than the second liquid outlet. However, the opposite is also possible, i.e. that the second liquid outlet is arranged at a shorter radial distance compared to the first liquid outlet.

The first and second liquid outlets may be arranged axially at the upper portion of the centrifuge bowl. Thus, both the inlet, and the two liquid outlets may be arranged at the axially upper portion of the centrifuge bowl.

As an example, also when the centrifugal separator comprises a second liquid outlet, the inlet may be hermetically sealed as discussed above. Thus, the centrifugal separator may have a hermetically sealed inlet and a first hermetically sealed first liquid outlet. The second liquid outlet may then be an open outlet or a hermetically sealed second liquid outlet.

As an example, the inlet and the first and second liquid outlets may all be sealed by at least one mechanical seal, and wherein the sealing surfaces of the at least one mechanical seal may be arranged in the same radial plane.

The at least one mechanical seal may be a single seal or two or more separate mechanical seals.

Moreover, as discussed in relation to the clarifier separator above, also when the centrifugal separator comprises a second liquid outlet, the centrifugal separator may be arranged such the liquid feed mixture enters the centrifuge bowl axially from the bottom. The liquid feed mixture may then enter the centrifuge bowl via a rotational shaft, a spindle, used for transmitting torque to the centrifuge bowl. The liquid feed mixture may thus enter at the rotational axis (X), the liquid light phase may be discharged at the rotational axis (X) and the liquid heavy phase may be discharged at a radial distance from the rotational axis (X).

All types of centrifugal separators used in the system of the first aspect of the invention may be a centrifugal separators arranged for multiple use. The centrifuge bowl may thus be a stainless-steel bowl. The centrifuge bowl may thus be arranged for multiple use. Further, the centrifuge bowl may comprise sludge outlets at the periphery of the bowl for intermittent or continuous discharge of a separated sludge phase.

The centrifugal separator of the system of the first aspect of the invention usually comprises a frame, i.e. a non-rotating part and the centrifuge bowl may be supported by the frame by at least one bearing device. The centrifuge bowl is usually supported by a spindle, i.e. a rotating shaft, and may thus be mounted to rotate with the spindle. The axis of rotation (X) may extend vertically. Consequently, the centrifugal bowl may be arranged such that the centrifuge bowl is supported by the spindle at one of its ends, such at the top end of the spindle. The centrifugal separator may further comprise a drive member for rotating the spindle and the centrifuge bowl. The drive member may comprise an electrical motor or be provided beside the spindle and rotate the spindle and centrifuge bowl by a suitable transmission, such as a belt or a gear transmission.

The centrifuge bowl comprises a separation space. In such separation space, usually a stack of separation discs is arranged. The separation of the liquid feed mixture takes place in the separation space. The separation discs may e.g. be of metal. Further, the separation discs may be frustoconical separation discs, i.e. having separation surfaces forming frustoconical portions of the separation discs. The separation discs are arranged coaxially around the axis of rotation (X) at a distance from each other such that to form passages between each two adjacent separation discs. The separation discs in the disc stack may be arranged such that the liquid mixture is introduced into the disc stack from a radially outer position. Separation then takes place in the passages between each two adjacent separation discs of the stack.

The centrifugal separator also comprises an inlet for liquid mixture to be separated (the liquid feed mixture). The inlet may comprise a central inlet chamber, from which the liquid feed mixture is guided to the separation space, e.g. via channels under or within a distributor as known in the art. The stack of separation discs usually rests on top of such distributor.

As a second aspect of the invention, there is provided a method of separating liquid feed mixture in a system according to the first aspect above, said method comprising the steps of
a) introducing the liquid feed mixture into the centrifugal separator using the liquid feed pump;
b) continuously discharging a first liquid phase from the first liquid outlet of the centrifugal separator;

This aspect may generally present the same or corresponding advantages as the former aspect. Effects and features of this second aspect are largely analogous to those described above in connection with the first aspect. Embodiments mentioned in relation to the first aspect are largely compatible with the second aspect of the invention.

The method may further comprise a step of
c) continuously discharging a second liquid phase from a second liquid outlet of the centrifugal separator.

The method may further comprise the step of a step of
d) intermittently discharging a sludge phase from the centrifugal separator.

The inventive concept disclosed herein may be used when separating a variety of different feed mixtures.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 is a schematic view of a prior art system for separating a liquid feed mixture.

FIG. 2 is a schematic view of a system according to the present disclosure in which the centrifugal separator is a top-fed clarifier.

FIG. 3 is a schematic view of a system according to the present disclosure in which the centrifugal separator is a bottom-fed clarifier.

FIG. 4 is a schematic view of a system according to the present disclosure in which the centrifugal separator is top fed and has a second liquid outlet.

FIG. 5 is a schematic view of a system according to the present disclosure in which the centrifugal separator is bottom fed and has a second liquid outlet.

FIG. 6 is a detailed view of the centrifugal separator of the system of FIG. 2 in a cross-sectional view.

FIG. 7 shows further details of the inlet and outlet of the centrifugal separator of FIG. 6.

FIG. 8 illustrates a perspective view of a single sealing element of a centrifugal separator.

FIG. 9 schematically illustrates a method of separating a liquid feed mixture.

### DETAILED DESCRIPTION

The system of the present disclosure will be further illustrated by the following description with reference to the accompanying drawings.

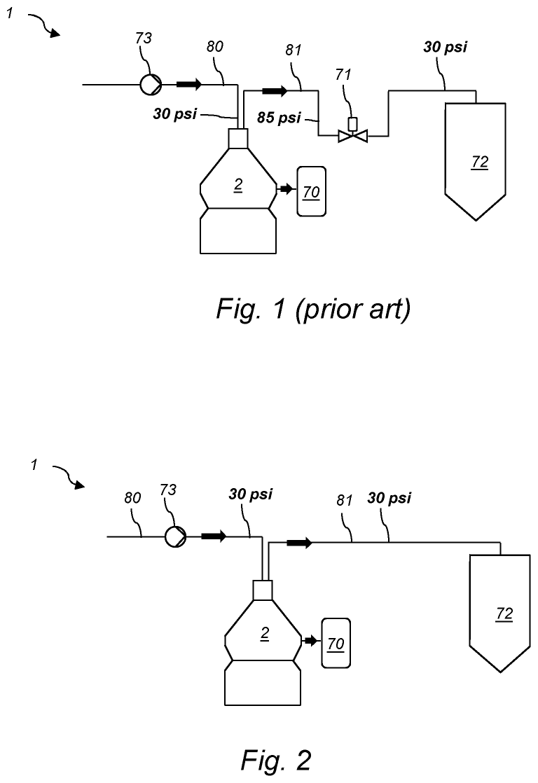

FIG. 1 shows a prior art system 1 used for separating a liquid feed mixture into a clarified first liquid phase. The centrifugal separator 2 of the system 1 is thus a clarifier centrifugal separator arranged for separating a first liquid phase and a sludge phase from the liquid feed mixture. The liquid feed mixture enters the centrifuge bowl via a stationary inlet pipe 80 using the liquid feed pump 73. The clarified first liquid phase is discharged in stationary outlet pipe 81 whereas the sludge phase is intermittently ejected via a set of sludge outlets arranged at the periphery of the centrifuge bowl, as known in the art. Separated sludge is collected in sludge tank 70 and the separated first liquid phase is collected in tank 72 arranged downstream of a first liquid outlet of the centrifugal separator. The first liquid outlet is a mechanically hermetically sealed outlet and is arranged in the centrifuge bowl of the centrifugal separator. Also the inlet of the centrifugal separator 2 is mechanically hermetically sealed. In order to create a flow of process fluid through the centrifugal separator 2, an inlet pressure has to be provided to overcome the pressure drop in the centrifugal separator 2. The inlet pressure is generated by the liquid feed pump 73

During separation in the centrifuge bowl, the separated first liquid phase moves towards the center of the centrifuge bowl and is then pumped out under pressure by means of a built-in pump wheel, which may rotate together with the centrifuge bowl in the first liquid outlet to obtain a required outlet pressure.

Thus, the generated inlet pressure by feed pump 73 is sufficient to overcome the flow resistance through the centrifugal separator to the built-in pump wheel at the first liquid outlet. The size of the pump wheel or pump impellers may be sized to suit the outlet pressure requirements.

Thus, in the prior art system of FIG. 1, the hermetically sealed first liquid outlet comprises a built-in pump wheel arranged for converting rotational energy into pressure flow of the first liquid phase. The built-in pump wheel is thus a dedicated device used for converting the kinetic energy of the separated liquid phase into pressure flow. Further, the centrifugal separator 2 requires a controlled counter pressure for optimal functionality. Such counter pressure is created using regulating valve 71 arranged downstream of the first liquid outlet, i.e. between the first liquid outlet and the tank 72. The regulating valve 71 is thus arranged for providing a pressure in the stationary outlet pipe 81. Typical pressure values (in psi) in different parts of the system are shown in FIG. 1.

The inventors have thus realised that the regulating valve 71 and the pump wheel of the liquid outlet used in prior art systems are not necessary. The generated counter pressure is more than what is required for downstream transportation of a separated liquid phase. That pressure drop is thus a loss of energy and in most cases not of any other benefit.

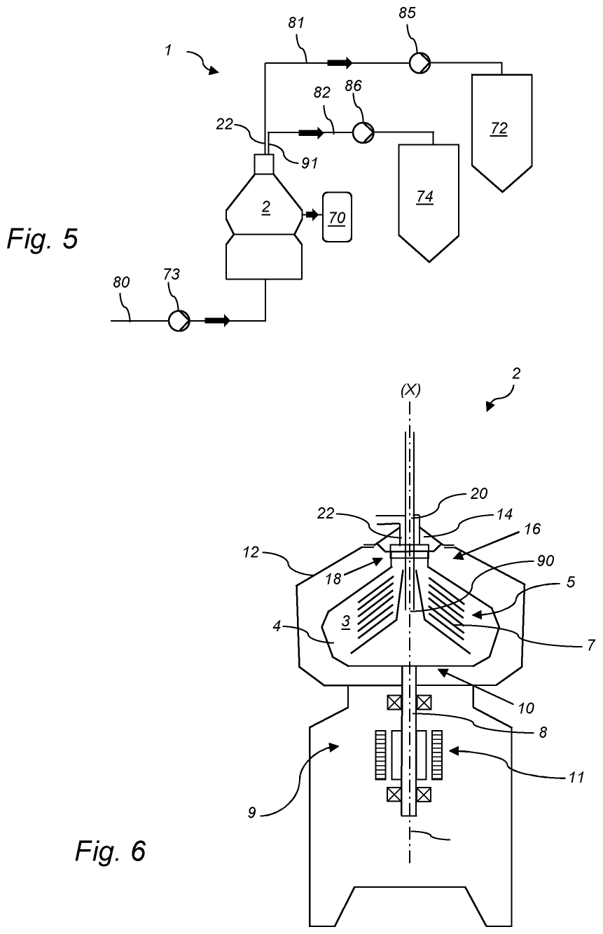

A system for separating at least a first liquid phase from liquid feed mixture according to the present disclosure is shown in FIG. 2. This system 1 comprises a clarifier centrifugal separator 2. The centrifugal separator 2 is discussed in more detail in relation to FIG. 5 below. The separator 2 at least comprises a centrifuge bowl arranged to rotate around an axis of rotation (X) and in which the separation of the liquid feed mixture takes place and an inlet for receiving the liquid feed mixture.

The liquid feed mixture enters the centrifuge bowl axially from the top via stationary pipe 80.

Further, the first, and single, liquid outlet for discharging the first liquid phase is hermetically sealed and arranged at the top of the centrifuge bowl. The centrifuge bowl is designed such that liquid feed mixture enters the bowl at the rotational axis and leaves the bowl via the first liquid outlet at a radial distance from the rotational axis. As in the prior art system of FIG. 1, sludge is ejected to sludge tank 70.

The first liquid outlet is free of any dedicated device, such as a pump wheel, for converting the kinetic energy of the first liquid phase into pressure flow of the first liquid phase. The system 1 further comprises the liquid feed pump 73 for supplying the liquid feed mixture to the inlet of the centrifugal separator. Due to the arrangement of the first liquid outlet, the liquid feed pump 73 is the major, or the only, flow regulating device arranged for creating the required outlet pressure for transportation of the first liquid phase downstream from the first liquid outlet to the tank 72 via the stationary pipe 81. Without any paring disc or pump wheel, no extra back pressure may be needed. Thus, as compared to the prior art system of FIG. 1, the regulating valve downstream of the first liquid outlet (valve 71 of FIG. 1) may be removed in the system 1 of the present disclosure. This severely reduces the energy consumption of the system. Consequently, the system 1 is free of any flow regulating valves between the first liquid outlet and the tank 72.

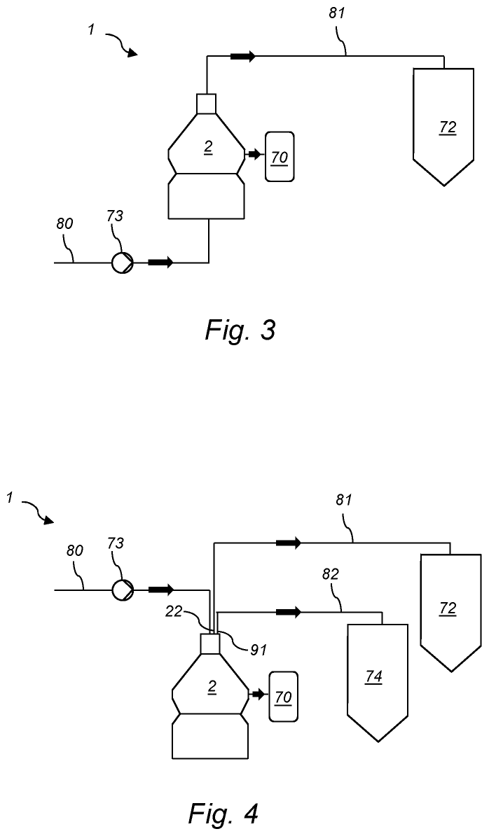

The system 1 as shown in FIG. 3 is substantially the same as the system of FIG. 2. However, in this setup, the centrifugal separator 2 is a bottom fed centrifugal separator, meaning that the liquid feed mixture enters the centrifuge bowl axially from the bottom at the rotational axis. Also in this design, the liquid outlet for the clarified liquid phase is arranged at the top of the centrifuge bowl and free of any dedicated device, such as a pump wheel, for converting the kinetic energy of the first liquid phase into pressure flow of the first liquid phase. Also, there is no regulating valve needed downstream of the first liquid outlet. In the bottom-fed design, also the clarified liquid phase may be discharged at the rotational axis, i.e. the first liquid outlet for the separated liquid phase is arranged such that the separated liquid phase is discharged at the rotational axis.

FIG. 4 shows a further embodiment of a system according to the present disclosure. In the system 1 as shown in FIG. 4, the liquid feed mixture—supplied via liquid feed pump 73 in the stationary pipe 80—is separated in the centrifugal separator 2 into a first liquid phase and a second liquid phase. Therefore, the centrifugal separator 1 comprises a second liquid outlet for discharging a second liquid phase having a density that is higher than the density of the first liquid. A sludge phase is discharged to tank 70 as in the previous examples.

In the design of FIG. 4, the second liquid outlet is an open outlet formed by an annular gravity disc. Thus, the second liquid outlet is an overflow outlet that is not hermetically sealed. Separated liquid heavy phase thus flows through this outlet out into stationary pipe 82. The liquid heavy phase may for example be pumped to tank 74 with a pump (not shown) arranged line 82. As an alternative, the liquid heavy phase may be collected in the sludge tank 70, e.g. via an internal passage in the separator 2, which therefore would allow removal of tank 74 from the system of FIG. 4.

The inlet and the first liquid outlet are hermetically sealed, and as in the systems discussed in relation to FIGS. 2 and 3, the first liquid outlet is free of any dedicated device, such as a pump wheel, for converting the kinetic energy of the first liquid phase into pressure flow of the first liquid phase. Separated liquid light phase is discharge to stationary pipe 81 and collected in tank 72.

If the interface position between the liquid light phase and liquid heavy phase within the centrifuge bowl is to be adjusted, the system 1 may comprise a pressure regulating means (not shown) between the first liquid outlet and tank 72. Such pressure regulating means may be used solely for applying a counter pressure for interface level control in the centrifuge bowl and may be other than a pressure regulating valve.

The centrifugal separator 1 is further arranged such that the liquid feed mixture enters the centrifuge bowl axially from the top at the rotational axis (X). Further, the first and second liquid outlets are arranged at the top and further arranged such that the first and second liquid phases are discharged at different radial distances from the rotational axis (X).

FIG. 5 also shows a system 1 in which the liquid feed mixture—supplied via liquid feed pump 73 in the stationary pipe 80—is separated in the centrifugal separator 2 into a first liquid phase and a second liquid phase. Thus, the centrifugal separator comprises a first liquid outlet as discussed in relation to FIG. 2 for discharging a first liquid phase, and also a second liquid outlet for discharging a second liquid phase having a density that is higher than the density of the first liquid. A sludge phase is discharged to tank 70 as in the previous examples.

Both the inlet as well as first and the second liquid outlets are hermetically sealed. The first and second liquid outlets are free of any dedicated device for converting the kinetic energy of the separated liquid phases into pressure flow. Moreover, the system 1 comprises a first pressure regulating means 85 downstream of the first liquid outlet and a second pressure regulating means 86 downstream of the second liquid outlet. These pressure regulating means 85, 86 are solely used for applying a counter pressure for interface level control in the centrifuge bowl, i.e. used for controlling the radial interface level between the first and second liquid phases during operation of the separator 2. The pressure regulating means 85, 86 may be positive displacement pumps or regulating valves.

In the system of FIG. 5, centrifugal separator 2 is arranged such that the liquid feed mixture enters the centrifuge bowl axially from the bottom, at the rotational axis. The first liquid phase is discharged at the rotational axis and the second liquid phase is discharged at a radial distance from the rotational axis.

FIG. 6 schematically illustrates the centrifugal separator 2 in the system discussed in relation to FIG. 2 above. The centrifugal separator 2 is configured for separating a liquid feed mixture into a liquid light phase and a sludge phase.

The centrifugal separator 2 comprises a centrifuge bowl 4. The bowl 4 is arranged to rotate about a rotational axis X extending along an axial extension. Herein, the axial extension serves to define positions of portions, parts, etc. of the centrifugal separator 2.

The bowl 4 is provided with a separation space 3. A stack 5 of frustoconical separation discs 7 is arranged inside the separation space 3. The centrifugal separator 2 further comprises a spindle 8 arranged at a first axial end portion 10 of the bowl 4 and arranged to rotate the bowl 4 about the rotational axis X. The spindle 8 forms part of a drive arrangement 9 of the centrifugal separator 2. In the illustrated embodiments, the drive arrangement 9 further comprises an electric motor 11. The bowl 4 is attached to the spindle 8. The spindle 8 forms part of the electric motor 11, i.e. the bowl 4 is directly driven by the electric motor 11. Thus, the drive arrangement 9 may rotate the bowl 4 about the rotational axis X. Alternatively, the drive arrangement 9 may comprise a spindle 8 connected to the bowl 4, an electric motor, and a transmission arranged between the electric motor and the spindle 8.

The centrifugal separator 2 further comprises a frame 12, which at least partially encloses the bowl 4 and a stationary liquid passage device 14 arranged at a second axial end portion 16 of the bowl 4. The stationary liquid passage device 14 is releasably connected to the frame 12. Moreover, the centrifugal separator 2 comprises a sealing arrangement 18, which forms an interface between the rotatable bowl 4 and the stationary liquid passage device 14.

A first liquid path 20 extends concentrically with the rotational axis 6 between the stationary liquid passage device 14 and the bowl 4. A second liquid path 22 extends radially outside the first liquid path 20 between the stationary liquid passage device 14 and the bowl 4.

The first liquid path 20 is arranged for conducting the liquid feed mixture into the centrifuge bowl 4, thereby forming part of a stationary inlet pipe or the inlet 90 of the centrifugal separator 2.

The second liquid path 22 thus forms part of a “first liquid outlet” as discussed above used for discharging the separated liquid light phase out of the centrifuge bowl. The first and second liquid paths 20, 22 are thus arranged in fluid communication with the separation space 3.

During separation of the liquid feed mixture in the separation space 3 of the bowl 4, the liquid feed mixture is lead via the first fluid path 20 from the centre of the bowl 4 into the separation space 3 and the disc stack 5. The liquid feed mixture is separated into a liquid light phase and a sludge. The separated liquid light phase flows radially inwardly between the separation discs 7 towards the rotational axis 6 and out of the bowl 4 via the second fluid path 22. The separated sludge phase flows radially outwardly between the separation discs 7 towards a periphery of the separation space 3 and out of the bowl 4 via sludge outlets (not shown), which may be intermittently opened.

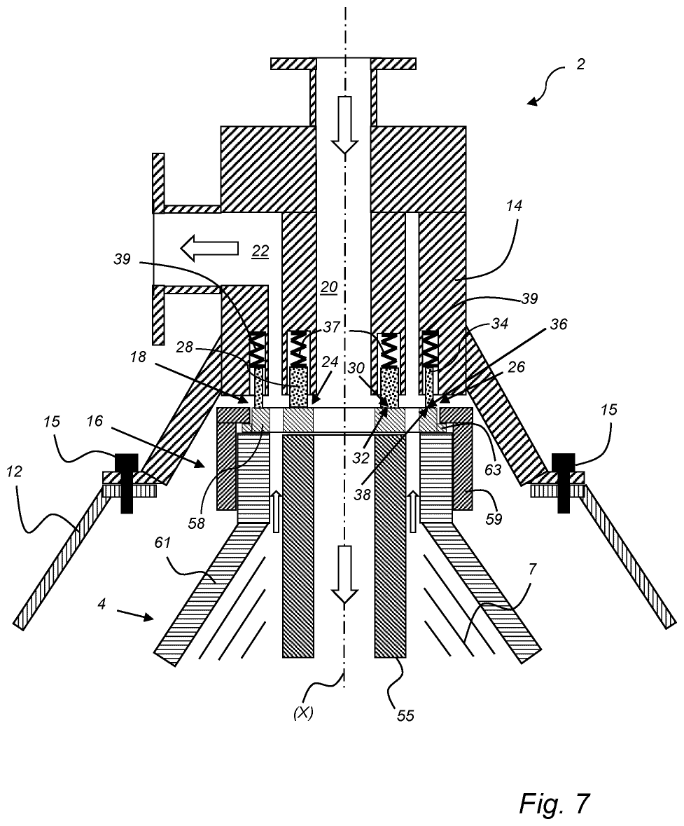

FIG. 7 schematically illustrates a cross section through the stationary liquid passage device 14 of the centrifugal separator of FIG. 6. The stationary liquid passage device 14 is releasably connected to the frame 12. In the illustrated embodiments, the stationary liquid passage device 14 is connected to the frame 12 with screws 15. Alternative, connections may comprise, claps, wing-nuts, etc.

In the illustrated embodiments, the first liquid path 20 forms part of an inlet for the liquid feed mixture and the second liquid path 22 forms part of an outlet for the separated liquid light phase.

The sealing arrangement 18 comprises a first seal 24 arranged between the first liquid path 20 and the second liquid path 22. The first seal 24 extends concentrically with and around the rotational axis X. The sealing arrangement 18 further comprises a second seal 26 arranged between the second liquid path 22 and a space radially outside the second liquid path 22. The second seal 26 extends concentrically with and around the rotational axis X. The second seal 26 also extends around the first seal 24.

The first, inner, seal 24 comprises a first seal member 28 arranged in the stationary liquid passage device 14 and a first sealing surface 30 arranged in the bowl 4. The first seal member 28 has a first axial end face 32 which is arranged in sealing abutment with the first sealing surface 30.

The second, outer, seal 26 comprises a second seal member 34 arranged in the stationary liquid passage device 14 and a second sealing surface 36 arranged in the bowl 4. The second seal member 34 has a second axial end face 38. The second axial end face 38 and the second sealing surface 36 are arranged in sealing abutment with each other.

The second seal member 34 is separate from the first seal member 28. In this manner, two individual seals are provided which means that each of them is adjustable independent of the other seal and also, that each of them is individually exchangeable.

Moreover, the first and second seal members 28, 34 are separable from the first and second sealing surfaces 30, 36 together with a release of the stationary liquid passage device 14 from the frame 12. In this manner, the first and second seal members 28, 34 are easily accessible e.g., for maintenance purposes, by dismounting of the stationary liquid passage device 14 from the frame 12.

The first seal member 28 is biased towards the first sealing surface 30 by one or more first resilient members 37. The second seal member 34 is biased towards the second sealing surface 36 by one or more second resilient members 39. In the illustrated embodiments, the first and second resilient members 37, 39 comprise a number of helical springs. The resilient members may alternatively comprise stacks of conical spring washers or pads of an elastic rubber material or other suitable members or combinations of members.

The first and second resilient members 37, 39 ensure that the first and second seal members 28, 34 are biased independently of each other. Accordingly, it is ensured that the first axial end face 32 is in sealing abutment with the first sealing surface 30 and that the second axial end face 38 is in sealing abutment with the second sealing surface 36, independently of each other.

The one or more first and second resilient members 37, 39 are arranged external of the first and second liquid paths 20, 22. That is, the first and second resilient members 37, 39 do not form any part of the first and second liquid paths 20, 22 and are dedicated to their biasing functions.

In the illustrated embodiment, the first and second sealing surfaces 30, 36 are arranged in one plane extending perpendicularly to the rotational axis 6. In this manner, the separability of the first and second seal members 28, 34 from the first and second sealing surfaces 30, 36 may be provided in a convenient manner.

However, according to alternative embodiments, the first and second sealing surface 30, 36 may be arranged one each in different planes that are axially spaced from each other. Such planes may be arranged at an axial distance from each other within a range of 0-25 mm.

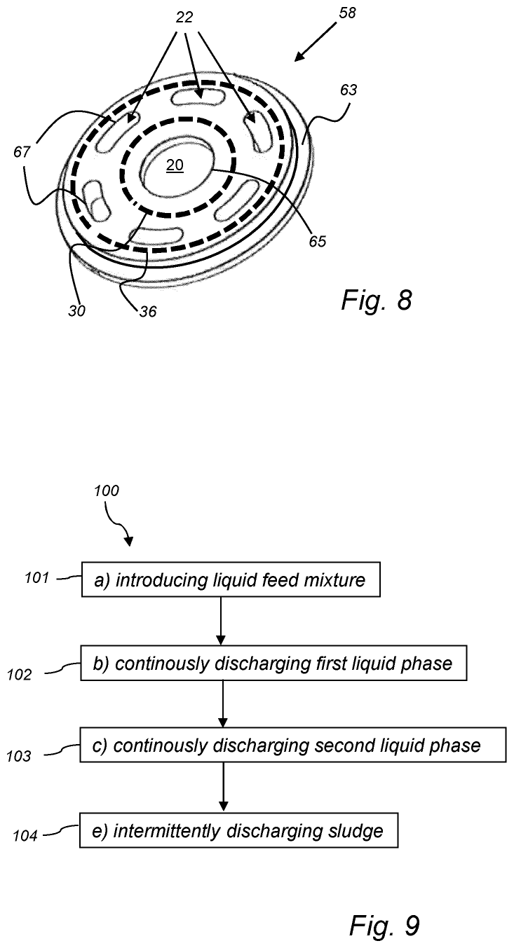

The first and second sealing surfaces 30, 36 are in this example provided in a single sealing element 58, as illustrated in FIG. 8. In this manner, the first and second sealing surfaces 30, 36 are conveniently provided in one single element that is mounted in the bowl 4. The single sealing element 58 forms at least part of an axial end of the bowl 4 at the second axial end portion 16 of the bowl 4. Thus, the first and second sealing surfaces 30, 36 are arranged at the axial end of the bowl 4 for the first and second axial end faces 32, 38 to abut thereagainst.

The single sealing element 58 is a single part which may be replaceable and accordingly, is releasably secured to the bowl 4. In the illustrated embodiments, the sealing element 58 is secured to the bowl 4 by a ring element 59. The ring element 59 is threadedly connect to a body 61 of the bowl 4. A flange 63 of the sealing element 58 is fixed between the body 61 of the bowl 4 and the ring element 59. According to alternative embodiments, the sealing element 58 may be releasably secured to the bowl 4 in a different manner e.g., utilising screws.

The single sealing element 58 forming at least part of an axial end of the bowl 4 at the second axial end portion 16 of the bowl 4 provides for a compact sealing arrangement 18. The sealing element 58 may be arranged close to a distributor 55 within the bowl 4. For instance, the first and second sealing surfaces 30, 36 may be arranged within a range of 0-50 mm from an axial end of the distributor 55. The distributor 55 is arranged concentrically with the rotational axis 6 and supports the stack of separation discs. Thus, separation members e.g., in the form of the illustrated separation discs 7 are arranged on the distributor 55.

In FIG. 7, sealing O-rings arranged between the single sealing element 58 and other parts of the bowl 4 as well as between the respective first and second seal members 28, 34 and other parts of the stationary liquid passage device 14, have been omitted for the sake of clarity.

In the perspective view of Fig, 8, the first and second sealing surfaces 30, 36 are indicated with broken lines.

The first liquid path 20 extends through the sealing element 58 and the second liquid path 22 extends through the sealing element 58. In this manner, the sealing element 58, that provides the first and second sealing surfaces 30, 36, can be provided in one single element. More specifically, the first liquid path 20 extends through a central opening 65 of the sealing element 58 and the second liquid path 22 extends through a number of passages 67 provided circumferentially around the central opening 65. The first sealing surface 30 is arranged between the central opening 65 and the second sealing surface 36 is arranged radially outside the passages 67.

The sealing element 58 comprises a flange 63 configured to be fixed between the body 61 of the bowl 4 and the ring element 59, see also FIG. 7.

Mentioned as examples, the first and second seal members 28, 34 may be made from carbon-graphite. The sealing element 58, or at least the first and second sealing surfaces 30, 36, may be made from silicon carbide or tungsten carbide. In this manner, good sealing and wear properties may be provided by the first and second seals 24, 26. According to a further example, which may be suitable when at least one of the process fluids contains abrasive matter, at least the first and second axial end faces 32, 38 of the first and second seal members 28, 34 as well as at least the first and second sealing surfaces 30, 36 of the sealing element 58, may be made from a hard material, such as silicon carbide or tungsten carbide.

FIG. 9 schematically illustrates the steps of a method 100 of separating a liquid feed mixture in a system 1 according to the present disclosure. The method 100 comprises a step 101 of a) introducing the liquid feed mixture into the centrifugal separator using the liquid feed pump and a step 102 of b) continuously discharging a first liquid phase from the first liquid outlet of the centrifugal separator. Moreover, for a system 1 designed for separating two liquid phases, the method 100 further comprises a step 103 of c) continuously discharging a second liquid phase from a second liquid outlet of the centrifugal separator. Moreover, for the purpose of discharging a sludge phase form the centrifugal separator, the method 100 comprises a step 104 of e) intermittently discharging a sludge phase from the centrifugal separator.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A system for separating at least a first liquid phase from a liquid feed mixture, said system comprising:
a centrifugal separator, comprising:
a centrifuge bowl arranged to rotate around an axis of rotation and in which the separation of the liquid feed mixture takes place;
an inlet for receiving said liquid feed-mixture, mixture; and
a first liquid outlet for discharging the first liquid phase, wherein said first liquid outlet is hermetically sealed and free of any dedicated device for converting the kinetic energy of the first liquid phase into pressure flow of the first liquid phase; and
a pressure generator for supplying the liquid feed mixture to the inlet of the centrifugal separator, and
wherein the system is configured such that the pressure generator is a major flow regulator arranged for creating a required outlet pressure for transportation of the first liquid phase from the first liquid outlet.

2. The system according to claim 1, wherein the centrifugal separator is free of further liquid outlets for discharge of further separated liquid phases.

3. The system according to claim 2, wherein the system further comprises a tank downstream of said first liquid outlet, and wherein the system is free of any pressure regulating valves between said first liquid outlet and said tank, wherein a pressure regulating valve is arranged for generating a counter pressure to the first liquid outlet.

4. The system according to claim 2, wherein the centrifugal separator is arranged such that the liquid feed mixture enters the centrifuge bowl axially from the top.

5. The system according to claim 4, wherein the liquid feed mixture enters the centrifugal separator at the rotational axis, and wherein the first liquid outlet is arranged such that the first liquid phase is discharged at a radial distance from the rotational axis.

6. The system according to claim 2, wherein the inlet is hermetically sealed.

7. The system according to claim 6, wherein the inlet and the first liquid outlet are hermetically sealed by-means of at least one mechanical seal, and wherein sealing interfaces of the at least one mechanical seal are arranged in the same radial plane.

8. The system according to claim 2, wherein the centrifugal separator is arranged such that the liquid feed mixture enters the centrifuge bowl axially from the bottom.

9. The system according to claim 1, wherein the centrifugal separator comprises a second liquid outlet for discharging a second liquid phase having a density that is higher than the density of the first liquid.

10. The system according to claim 9, wherein the second liquid outlet is hermetically sealed and free of any dedicated device for converting the kinetic energy of the second liquid phase into pressure flow of the second liquid phase.

11. The system according to claim 10, wherein the system comprises a first pressure regulator downstream of the first liquid outlet and a second pressure regulator downstream of the second liquid outlet, wherein said first and second pressure regulators are arranged for regulating the interface between the liquid phases within the centrifuge bowl and are other than pressure regulating valves.

12. The system according to claim 9, wherein the second liquid outlet is an open outlet formed by an annular gravity disc.

13. The system according to claim 9, wherein the centrifugal separator is arranged such that the liquid feed mixture enters the centrifuge bowl axially from the top.

14. The system according to claim 13, wherein the liquid feed mixture enters the centrifugal separator at the rotational axis, and wherein the first and second liquid outlets are arranged such that the first and second liquid phases are discharged at different radial distances from the rotational axis.

15. The system according to claim 14, wherein the inlet is hermetically sealed.

16. The system according to claim 15, wherein the inlet and the first and second liquid outlets are sealed by at least one mechanical seal, and wherein sealing surfaces of the at least one mechanical seal are arranged in the same radial plane.

17. The system according to claim 9, wherein the centrifugal separator is arranged such that the liquid feed mixture enters the centrifuge bowl axially from the bottom.

18. The system according to claim 3, wherein the centrifugal separator is arranged such that the liquid feed mixture enters the centrifuge bowl axially from the top.

19. The system according to claim 3, wherein the inlet is hermetically sealed.

20. The system according to claim 4, wherein the inlet is hermetically sealed.
